(19) United States
(12) Patent Application Publication
(10) Pub. No.: US 2010/0077669 A1
(43) Pub. Date: Apr. 1, 2010

(54) Foam material sealing strip

(76) Inventor: Ruediger DANIEL, Wermelskirchen (DE)

Correspondence Address: CALFEE HALTER & GRISWOLD, LLP, 800 SUPERIOR AVENUE, SUITE 1400, CLEVELAND, OH, 44114, US

(21) Appl. No.: 12/383,380

(22) Filed: Mar. 24, 2009

(30) Foreign Application Priority Data
Sep. 27, 2008 (DE) 102008049210.8

(51) Int. Cl. E06B 7/16

(52) U.S. Cl. 49/475.1

(57) ABSTRACT

The invention relates to a foam material sealing strip (1) for sealing a window frame with reference to an opening side wall. It is proposed that different foam material strips (5, 6) are impregnated for delayed recovery, in each instance, that the foam material strips (5, 6) extend over the entire thickness (d) of the foam material sealing strip (1), in each instance, and extend next to one another, at their facing longitudinal sides (7, 8), without being glued together, at least in part, in such a manner that the foam material sealing strip (1) is air-permeable in the crosswise direction, whereby the air permeability of the foam material sealing strip (1) is determined solely by the combination of the air permeability values of the impregnated foam material strips (5, 6), in each instance, and that the different vapor braking effect is achieved by means of a different initial density and/or a different impregnation of the foam material strips.

The invention relates to a foam material sealing strip suitable for sealing a window frame with reference to an opening side wall, which strip is at least partially saturated, for delayed recovery, whereby the foam material sealing strip has two longitudinal sides that lie opposite one another and face the room interior and the room exterior, respectively, in the installed state, and furthermore has a top and a bottom that lie opposite one another, for making contact with the window side and the opening side wall, respectively, whereby the foam material sealing strip is furthermore configured differently, by means of different foam material strips, which are, however, open-pore strips, in each instance, and are joined together, assigned to the longitudinal sides, which strips are held together by means of an adhesive layer that covers one side, in such a manner that in the installed state, in any case, a different vapor braking effect is obtained.

Such a foam material sealing strip is known from DE102006043050A1. In the known foam material sealing strip, an additional foam material connected in non-releasable manner with the otherwise uniform foam material of the foam material sealing strip is provided for this purpose, on one side—with reference to the longitudinal edge side. Either as a closed-cell foam material, thereby already resulting in the desired higher vapor braking effect solely in the case of a pocket-like formation of the remaining foam material region, in which the additional foam material lies. Or in the form of open-cell foam material, thereby resulting in greater compression and thus the desired higher vapor braking effect, as the result of a greater initial height of the foam material sealing strip formed in this manner, assigned to this longitudinal edge region, in the installed state.

With regard to the state of the art, DE20009674U1 should furthermore be pointed out Here, multiple foam material strips that are connected with one another over their width are provided, whereby an airtight barrier layer is formed between at least two of the foam material strips. A similar configuration, but with foam material layers that are the same, is known from DE3544277C1.

Proceeding from the prior art first mentioned, the invention is based on the task of indicating an advantageous foam material sealing strip for sealing a window frame with regard to an opening side wall.

A possible solution for this task is given by the object of claim 1, whereby in this case, the important factor is that the different foam material strips are impregnated for delayed recovery, in each instance, that the foam material strips extend over the entire thickness of the foam material sealing strip, in each instance, and extend next to one another, at their facing longitudinal sides, without being glued together, at least in part, in such a manner that the foam material sealing strip is air-permeable in the crosswise direction, whereby the air permeability of the foam material sealing strip is determined solely by the combination of the air permeability values of the impregnated foam material strips, in each instance, and that the different vapor braking effect is achieved by means of a different initial density and/or a different impregnation of the foam material strips. Fundamentally, an air-permeable foam material sealing strip is present, which is comprised in total—only—of open-pore foam material. Because the foam material strips extend over the entire thickness of the foam material sealing strip, in each instance, a simple structure is achieved. The fact that the foam material sealing strips extend next to one another at their facing longitudinal sides, without being glued together, preferably also resting directly against one another at these sides, ensures defined conditions. It is true that a certain hold is given, in practical situations, by means of impregnation substance that might exit at this interface.

However, this does not result in any gluing in the sense of a connection that can only be eliminated by destroying it. This is because the impregnation substance does not harden. The different vapor braking effect is achieved solely by means of a different initial density and/or a different impregnation of the foam material strips. Fundamentally, no other additional means such as greater compression achieved by means of inserting a molding or the like, or a coating on one side, are required.

Since the contact of the foam material strips at their longitudinal sides, without gluing, is not supposed to hinder the air permeability in the crosswise direction of the foam material sealing strip, there is the possibility, on the one hand, that the foam material strips extend next to one another completely without gluing. On the other hand, there is also the possibility that certain glue connections that do not hinder the air permeability, or do not hinder it significantly, are provided. For example, the foam material strips can be glued to one another on their facing longitudinal sides, leaving regions that are free of gluing. The regions free of gluing can compose 20% to 90% of the side surface, in particular, whereby this said range also includes all the intermediate values, particularly in steps of one-tenth of a percent, in the disclosure.

As a further detail, such gluing can be provided in raster-like manner. Furthermore, it can also be provided by means of isolated glue points. Preferably, gluing is provided in such a manner that it can be eliminated only in destructive manner, in other words by tearing out foam material regions that have been glued together, for example.

Although it is preferred that the foam material strips lie directly against one another, they can also leave a gap between them. Preferably, the gap, which accordingly extends crosswise to the plane expanse of the adhesive layer that is used for attachment, for example on a frame part, is then open on one side, but closed off on the other side by the covering adhesive layer. In the crosswise direction, the gap can have a dimension of a few tenths of a millimeter up to a few millimeters. In individual cases, also depending on the total width of the foam material sealing strip, up to as much as one or more centimeters.

With regard to the impregnation agent, this is preferably an acrylate-based impregnation agent, in a further detail. Furthermore, this agent is preferably adjusted in such a manner that an impregnated foam material strip that is pressed onto a glass plate can be removed without residue. This is not possible in the case of an adhesive such as that also used for the self-adhesive strip, for example.

The raw densities of the foam materials used can be selected between 20 and 50, preferably between 25 and 40 kg/m³. In the impregnated state, which then also corresponds to the initial density mentioned here, a density between 40 and 120, preferably between 50 and 100 kg/m³, can be selected. The disclosure also includes the intermediate values, in detail, in each instance. For example 21 or 49 or 41, 119 etc. kg/m³.

The different vapor braking effect can be expressed by means of the vapor diffusion resistance number μ. This is a measure of the resistance with which the—saturated—foam material strip counters the water vapor (air humidity) in comparison with a meter of air layer thickness. Reference is made to DIN 18542. In this connection, the foam material strip that faces the room interior can have a μ value of 5 to 20, preferably 8 to 15, further preferably 10. In contrast, the foam material strip that faces the room exterior can have a μ value of 2 to 15, preferably 4 to 10, further preferably 4.5 or 5. In the case of these values, as well, all the intermediate values, including those in the range of a tenth of a step, are included in the disclosure.

Further characteristics of the invention will be explained below, also in the figure description, often in their preferred relationship to the object of claim 1, or to characteristics of other claims. However, they can be of significance also in their relationship to only individual characteristics of claim 1, or of the other claim, in each instance, or also independently.

For example, it is preferred that the foam material strips have the same initial thickness. In the complete recovered state, which is, however, not achieved as such in practical situations, since a certain compression always remains in the installed state, the foam material strips that lie next to one another therefore return to the same height. However, this also means that the recovery forces are practically the same over the width of the foam material sealing strip.

Furthermore, it is preferred that the width of the foam material strips is different. In this way, advantageous adaptation to the use conditions can be achieved. For example in that the foam material strip assigned to the room exterior, which is more exposed to weathering influences, is configured over a greater depth than the foam material strip that faces the room interior. The latter is specifically also the more preferred embodiment, although a reverse configuration is possible in individual cases, namely that the foam material strip that faces the inside has the lesser width.

In the following, the invention will be explained further using the attached drawing, but this merely shows an embodiment as an example. In this connection, the drawing shows:

### BRIEF DESCRIPTION OF THE DRAWINGS

FIG. 1 in a schematic, perspective representation, a foam material sealing strip that has been partly rolled up;

FIG. 2 an enlarged cross-section of the sealing strip according to FIG. 1;

FIG. 3 in a schematic, sectional representation, an installation situation of the sealing strip according to FIG. 1 and FIG. 2, respectively;

FIG. 4 a representation according to FIG. 2, but with the foam material strips being glued together at their facing longitudinal sides; and

FIG. 5 a section through the object according to FIG. 4, cut along the line V-V.

### DETAILED DESCRIPTION OF THE INVENTION

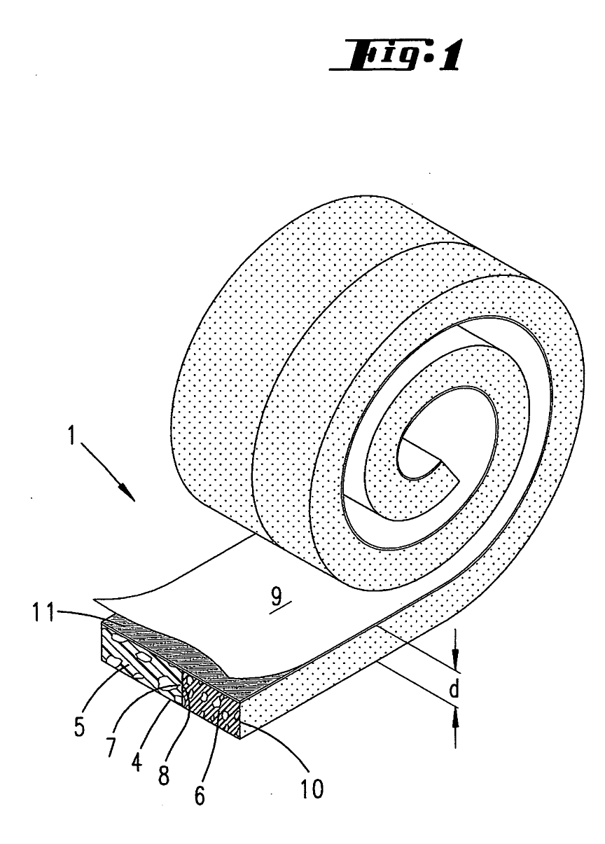

With reference to FIG. 1 to 3, what is shown and described is a foam material sealing strip 1 that preferably serves for installation between a window frame 2 and an opening side wall 4 of a building, provided by a masonry wall 3, see FIG. 3.

The foam material sealing strip 1 is composed of two foam material strips 5, 6 that run parallel to one another. Preferably, it is also composed only of these two foam material strips 5, 6. The foam material strips 5, 6 lie directly against one another at their facing inner longitudinal sides 7, 8. They can also leave a gap between them. The gap is then preferably the two foam material strips 5, 6 consist of an open-pore, i.e. open-cell soft foam material. The combined foam material strips 5, 6, i.e. the foam material sealing strip 1, furthermore have/has a top 9 that comes to lie against the window side, and a bottom 10 that comes to lie against the opening side wall 10 (see FIG. 3).

The foam material strips 5, 6 are held together by means of an adhesive layer 11 that simultaneously forms the top 9. In the exemplary embodiment, the adhesive layer 11 consists of a double-sided self-adhesive layer, whereby the adhesive can be provided saturated in a nonwoven material or a woven material, for example.

The two foam material strips 5, 6 are impregnated for delayed recovery. The two foam material strips 5, 6 also extend over the entire thickness d of the foam material sealing strip 1. Preferably, as shown in the exemplary embodiment, the longitudinal edge sides 7, 8 of the foam material strips 5, 6 also run perpendicular to the top 9 and the bottom 10, respectively. Thus, only one and the same foam material, either that of the foam material strip 5 or of the foam material strip 6, is present in every longitudinal plane that stands perpendicular to the top 9 or the bottom 10, respectively.

The foam material strips 5, 6 are not glued to one another. Fundamentally, it is therefore possible to dispose the foam material strips 5, 6 spaced apart from one another, in cross-section, proceeding from the adhesive layer 11, by means of a certain bend in the region of the adhesive layer 11.

The foam material that has been selected is furthermore preferably a polyurethane soft foam. This is impregnated for delayed recovery, in each instance. For example with an acrylate-based impregnation substance. In its provisioning form, the foam material sealing strip 1 can also be held in a tear-open wrapping foil/film. In this regard, reference is made to EP 1131525B1, for example.

With regard to the possible accommodation of the foam material sealing strip 1 in the aforementioned tear-open wrapping foil/film, the content of the aforementioned document is completely incorporated into the disclosure of the present application, also for the purpose of including characteristics of this document in claims of the present invention.

The widths B1 of the foam material strip 5 and B2 of the foam material strip 6 are different. In the exemplary embodiment, B2 is less than B1. B2 preferably corresponds to about 10 to 49% of B1, whereby all intermediate values, not only in the form of whole numbers, but also in values of hundredths or tenths, are included in the disclosure, in such a manner that any such intermediate value can be claimed as an exact value or as a range/limit value.

In contrast, the initial thickness of the foam material strips is preferably the same. In other words, the thickness before compression or after complete recovery has taken place.

Furthermore, however, it is essential that the foam material strips 5, 6 possess a different vapor braking effect. This can be achieved, on the one hand, by means of a differently strong impregnation, or the selection of a different density of the starting foam material. In this connection, the vapor braking effect that faces the building interior is adjusted to be higher than that facing the building exterior.

The width, in other words the total of B1 and B2, of the foam material sealing strip, corresponds to about ten times the thickness d in the compressed provisioning state, while in the installed state, in other words in the decompressed rest state, a ratio of the stated width to the thickness of about 5:1 is present (this thickness is also referred to as join width in technical terms, while the—composite—dimension referred to as width above is also referred to as join depth in technical terms). The total width, B1 plus B2, of such a foam material sealing strip 1, corresponds to the total width of a window frame, in other words lies between 5 and 20 cm. In the case of a gap between the foam material strips, this gap is also included in the said total width.

The adhesive layer 11 is covered by a protective foil/film 9 in the storage state. This can be siliconized foil/film, for example.

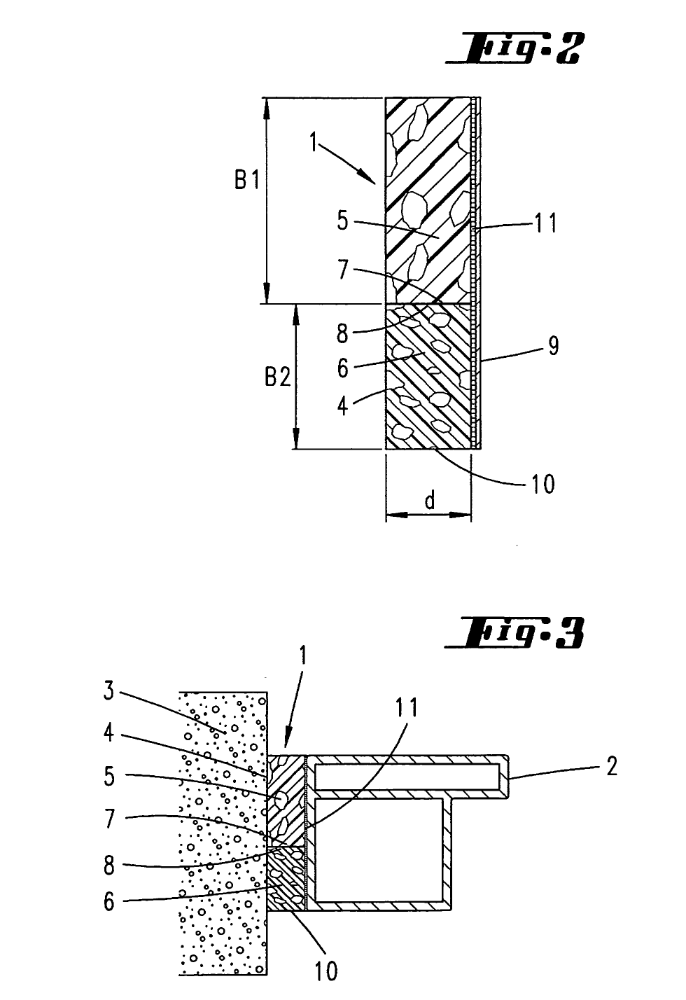

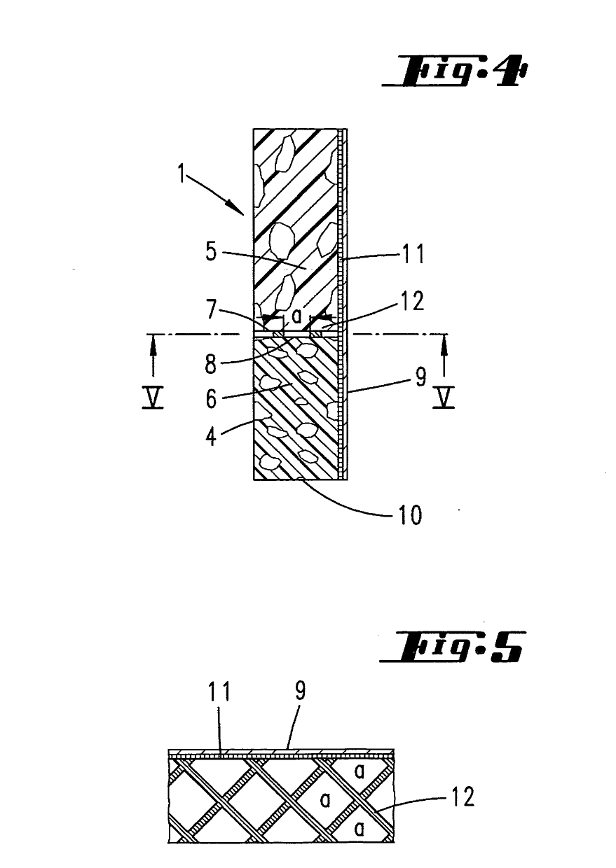

In the embodiment of FIG. 4, which otherwise corresponds to the embodiment of FIG. 2, a gluing 12 is provided between the facing inner and longitudinal sides 7, 8 of the foam material strips 5, 6. The gluing 12 is carried out in such a manner that a region a is formed between individual glue locations 12, in which the foam material strips 5, 6 merely lie against one another, as also described above (or are actually separated from one another by a gap, in accordance with the representation).

In FIG. 5, the representation shows a possible configuration of the gluing 12 in the form of adhesive strips disposed in shortening form. The adhesive strips can extend to the top 9 or the adhesive layer 11, respectively, enclosing an acute angle. In detail, diamond-shaped intermediate regions a are formed in the embodiment shown. The intermediate regions a are regions in which the foam material strips 5, 6 lie against one another, without gluing, or are actually spaced apart from one another.

All the characteristics disclosed are essential to the invention (in and of themselves). The disclosure content of the related/attached priority documents (copy of the prior application) is also included in the disclosure of the application, to its full extent, also for the purpose of including characteristics of these documents in the claims of the present application.

### REFERENCE SYMBOL LIST

1 foam material sealing strip
1.2 window frame
1.3 masonry wall
1.4 opening side wall
1.5 foam material strip
1.6 foam material strip
1.7 longitudinal side
1.8 longitudinal side
1.9 top
1.10 bottom
1.11 adhesive layer

a intermediate region

b thickness

BI width

B2 width

1. A foam material sealing strip suitable for sealing a window frame with reference to an opening side wall, which strip is at least partially saturated, for delayed recovery, whereby the foam material sealing strip comprises two longitudinal sides that lie opposite one another and face the room interior and the room exterior, respectively, in the installed state, and furthermore has a top and a bottom that lie opposite one another, for making contact with the window side and the opening side wall, respectively, whereby the foam material sealing strip is furthermore configured differently, by means of different foam material strips, which are, however, open-pore strips, in each instance, and are joined together, assigned to the longitudinal sides, which strips are held together by means of an adhesive layer that covers one side, in such a manner that in the installed state, in any case a different vapor braking effect is obtained, characterized in that the different foam material strips are impregnated for delayed recovery, in each instance, that the foam material strips extend over the entire thickness of the foam material sealing strip in each instance, and extend next to one another, at their facing longitudinal sides, without being glued together, at least in part, in such a manner that the foam material sealing strip is air-permeable in the crosswise direction, whereby the air permeability of the foam material sealing strip is determined solely by the combination of the air permeability values of the impregnated foam material strips in each instance, and that the different vapor braking effect is achieved by means of a different initial density and/or a different impregnation of the foam material strips.

2. The foam material sealing strip according to claim 1, wherein the foam material strips extend next to one another, over their full area, at their longitudinal sides that face one another, without gluing.

3. The foam material sealing strip according to one claim 1, wherein the foam material strips lie directly against one another at their facing longitudinal strips.

4. The foam material sealing strip according to claim 1, wherein the foam material strips have the same initial thickness.

5. The foam material sealing strip according to claim 1, wherein the width of the foam material strips is different.

6. The foam material sealing strip according to claim 1, wherein the foam material strip that faces the room interior has a lesser width than the outer foam material strip.

7. The foam material sealing strip according to claim 1, wherein the foam material strips are glued together at their facing longitudinal sides, leaving regions that are free of glue.

8. The foam material sealing strip according to claim 1, wherein the foam material strips are glued together in raster-like manner at their facing longitudinal sides.
